(19) United States
(12) Patent Application Publication
(10) Pub. No.: US 2025/0337186 A1
(43) Pub. Date: Oct. 30, 2025

(54) ELECTRICAL CONNECTOR HAVING TERMINALS WITH LOCKING LANCES

(71) Applicants: TE Connectivity Solutions GmbH, Schaffhausen (CH); Tyco Electronics UK Ltd, Swindon (GB)

(72) Inventors: Richard C. Batley, Jonestown, PA (US); John Marsh, Swindon (GB)

(21) Appl. No.: 19/089,591

(22) Filed: Mar. 25, 2025

Related U.S. Application Data
(60) Provisional application No. 63/638,766, filed on Apr. 25, 2024.

(51) Int. Cl. H01R 13/432; H01R 13/04; H01R 13/11; H01R 13/627

(52) U.S. Cl. CPC H01R 13/432; H01R 13/04; H01R 13/111; H01R 13/6273

(57) ABSTRACT

An electrical connector includes a connector housing having a base with terminal cavities and a retention shoulder within each terminal cavity. Terminals are received in the corresponding terminal cavities. Each terminal includes a main body extending between a mating end at a front of the terminal and a terminating end at a rear of the terminal. Each terminal includes a locking lance extending from the main body. The locking lance includes a lance arm extending in the axial direction of the terminal and a retention finger extending transversely from the lance arm to a retention edge. The retention edge engages the corresponding retention shoulder to retain the terminal in the corresponding terminal cavity.

### CROSS REFERENCE TO RELATED APPLICATIONS

This application claims benefit to U.S. Provisional Application No. 63/638,766, filed 25 Apr. 2024, the subject matter of which is herein incorporated by reference in its entirety.

### BACKGROUND OF THE INVENTION

The subject matter herein relates generally to electrical connectors.

Electrical connectors are used within electrical connector systems to provide an electrical connection between various components of the system. For example, the electrical connectors may transmit data and/or power across the connector interface. Electrical connectors terminated to ends of cables are known as cable connectors and the cables transmit the data and/or power to/from the electrical connector to a remote location within the system. The cables are terminated to terminals, which are held in a housing for mating with the mating electrical connector. Assembly of the electrical connector may be problematic. For example, properly locating the terminals in the housing for mating with the mating connector may be difficult. Improperly loaded terminals are subject to damage or improper mating when mating with the mating connector. Some known terminals include locking lances used to locate and secure the terminals in the housing. The locking lances may be damaged if pull-out forces are exceeded. Additionally, the locking lances increase the overall lengths of the terminals, thus increasing the size of the electrical connector.

### BRIEF DESCRIPTION OF THE INVENTION

In one embodiment, an electrical connector is provided and includes a connector housing that includes a base and a plurality of terminal cavities extending through the base. The base includes a retention shoulder within each terminal cavity. The electrical connector includes terminals received in the corresponding terminal cavities. Each terminal includes a main body extending between a mating end at a front of the terminal and a terminating end at a rear of the terminal. The mating end is configured to be mated to a mating terminal. The terminating end configured to be terminated to a cable. Each terminal includes a locking lance extending from the main body. The locking lance includes a lance arm extending in the axial direction of the terminal and a retention finger extending transversely from the lance arm to a retention edge. The retention edge engages the corresponding retention shoulder to retain the terminal in the corresponding terminal cavity.

In another embodiment, an electrical connector is provided and includes a connector housing that includes a base and a plurality of terminal cavities extending through the base. The base includes a retention shoulder within each terminal cavity. The electrical connector includes terminals received in the corresponding terminal cavities. Each terminal includes a main body extending between a mating end at a front of the terminal and a terminating end at a rear of the terminal. The mating end is configured to be mated to a mating terminal. The terminating end configured to be terminated to a cable. Each terminal includes a locking lance extending from the main body. The locking lance includes a lance arm extending between a fixed end and a free end. The fixed end is located rearward of the free end. The locking lance includes a retention finger extending from the free end engaging the corresponding retention shoulder to retain the terminal in the corresponding terminal cavity.

In a further embodiment, an electrical connector is provided and includes a connector housing that includes a base and a plurality of terminal cavities extending through the base. The base extends between a front and a rear. The base includes a locating tube extending at least a length of each terminal cavity. The base includes a retention shoulder within each terminal cavity forward of the locating tube. The electrical connector includes terminals received in the corresponding terminal cavities. Each terminal includes a main body extending between a mating end at a front of the terminal and a terminating end at a rear of the terminal. The mating end is configured to be mated to a mating terminal. The terminating end configured to be terminated to a cable. The main body has a locating portion received in the locating tube to coaxially position the terminal in the terminal cavity. Each terminal includes a locking lance extending from the main body. The locking lance includes a lance arm extending forwardly generally in the axial direction of the terminal. The lance arm is located along the locating portion and received in the locating tube. The locking lance includes a retention finger protruding outwardly and transversely to the lance arm and extending generally rearwardly from the lance arm to a retention edge. The retention edge engages the corresponding retention shoulder to retain the terminal in the corresponding terminal cavity.

### BRIEF DESCRIPTION OF THE DRAWINGS

FIG. 1 illustrates an electrical connector system in accordance with an exemplary embodiment showing a first electrical connector and a second electrical connector poised for mating with each other.

FIG. 2 illustrates the electrical connector system in accordance with an exemplary embodiment showing the first electrical connector and the second electrical connector mated together.

FIG. 3 illustrates an exploded view of the electrical connector system in accordance with an exemplary embodiment.

FIG. 4 illustrates a front perspective view of an exemplary embodiment of the terminal in accordance with an exemplary embodiment.

FIG. 5 illustrates a front perspective view of an exemplary embodiment of the terminal in accordance with an exemplary embodiment.

FIG. 6 illustrates enlarged views of a portion of the terminal in accordance with an exemplary embodiment.

FIG. 7 illustrates enlarged views of a portion of the terminal in accordance with an exemplary embodiment.

FIG. 8 illustrates a front perspective view of an exemplary embodiment of the terminal in accordance with an exemplary embodiment.

FIG. 9 illustrates a front perspective view of an exemplary embodiment of the terminal in accordance with an exemplary embodiment.

FIG. 10 is a sectional view of the electrical connector system showing the first electrical connector and the second electrical connector mated together in accordance with an exemplary embodiment.

FIG. 11 is an enlarged view of a portion of the electrical connector system showing one of the terminals positioned in the connector housing in accordance with an exemplary embodiment.

FIG. 12 is an enlarged view of a portion of the electrical connector system showing one of the terminals positioned in the connector housing in accordance with an exemplary embodiment.

### DETAILED DESCRIPTION OF THE INVENTION

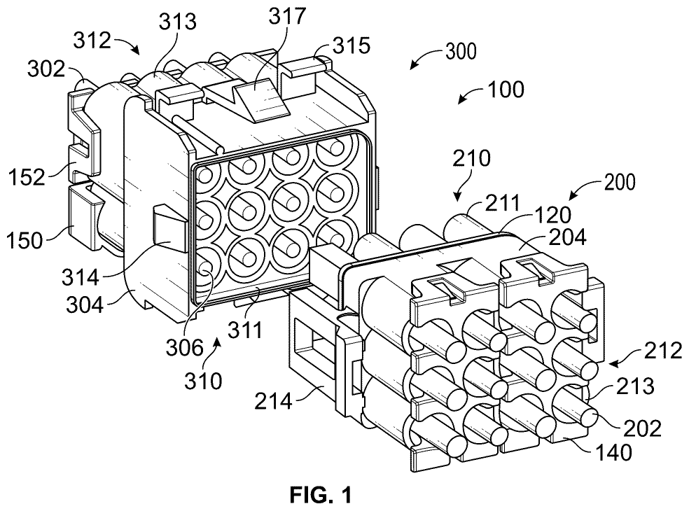

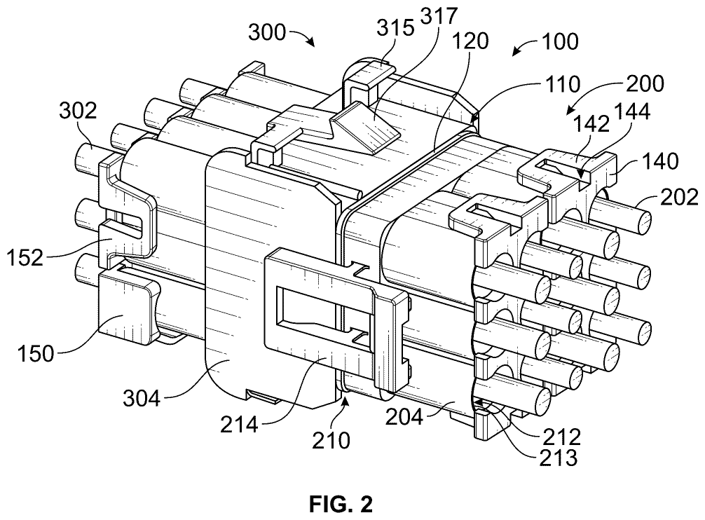

FIG. 1 illustrates an electrical connector system 100 in accordance with an exemplary embodiment showing a first electrical connector 200 and a second electrical connector 300 poised for mating with each other. FIG. 2 illustrates the electrical connector system 100 in accordance with an exemplary embodiment showing the first electrical connector 200 and the second electrical connector 300 mated together.

The electrical connectors 200, 300 are configured to be mated at a separable mating interface 110. The electrical connector 300 is considered a mating electrical connector for the electrical connector 200 and components thereof may be identified hereinafter as “mating” components. The electrical connector 200 is considered a mating electrical connector for the electrical connector 300 and components thereof may be identified hereinafter as “mating” components.

In the illustrated embodiment, the electrical connectors 200, 300 are cable electrical connectors provided at ends of cables 202, 302, respectively. In an exemplary embodiment, the electrical connectors 200, 300 are power connectors configured to transmit power across the separable mating interface; however, the electrical connectors 200, 300 may additionally or alternatively transmit data across the separable mating interface. In various embodiments, the electrical connectors 200, 300 may be used in automotive applications, industrial applications, appliances, or other applications.

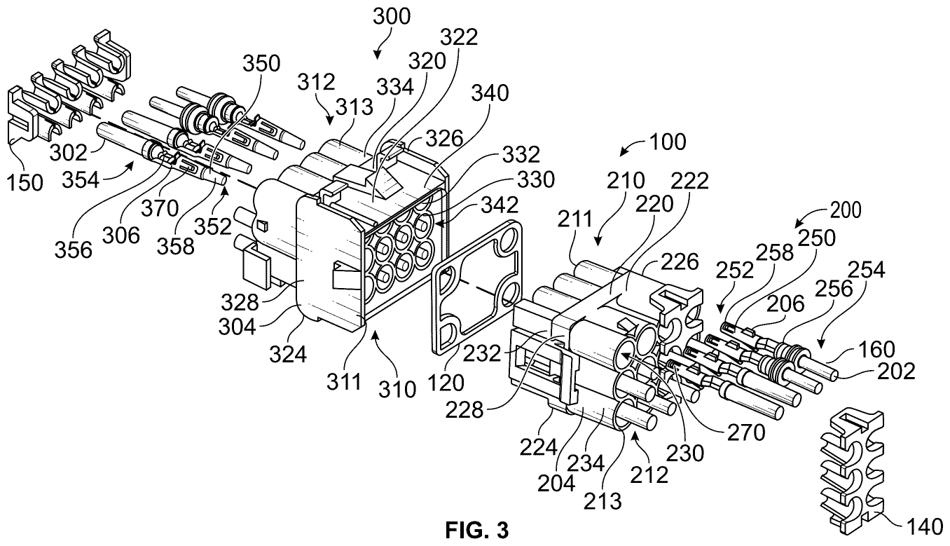

The electrical connector 200 includes a connector housing 204 holding terminals 206 (shown in FIG. 3). The terminals 206 are terminated to corresponding cables 202. The connector housing 204 extends between a mating end 210 at a front 211 of the connector housing 204 and a cable end 212 at a rear 213 of the connector housing 204. The cables 202 extend from the cable end 212. The mating end 210 is configured to be mated to the electrical connector 300.

In an exemplary embodiment, the electrical connector 200 includes one or more terminal position assurance (TPA) devices 140 coupled to the connector housing 204. The TPA devices 140 are used to ensure that the terminals 206 are properly loaded and retained in the connector housing 204. In the illustrated embodiment, the TPA devices 140 are coupled to the rear 213 of the connector housing 204. The cables 202 extend through the TPA devices 140. Proper installation of the TPA devices 140 provides assurance to the installer that the terminals 206 are properly installed within the connector housing 204.

In the illustrated embodiment, the mating end 210 of the connector housing 204 is configured to be plugged into the electrical connector 300. The electrical connector 200 thus defines a plug connector and the mating electrical connector 300 defines a receptacle connector that receives the mating end 210 of the plug connector 200.

The electrical connector 300 includes a connector housing 304 holding terminals 306. The terminals 306 are terminated to corresponding cables 302. The connector housing 304 extends between a mating end 310 at a front 311 of the connector housing 304 and a cable end 312 at a rear 313 of the connector housing 304. The cables 302 extend from the cable end 312. The mating end 310 is configured to be mated to the electrical connector 200.

In the illustrated embodiment, the mating end 310 of the connector housing 304 defines a receptacle that receives the mating end 210 of the electrical connector 200. The electrical connector 300 thus defines a receptacle connector and the mating electrical connector 200 defines a plug connector.

In an exemplary embodiment, the electrical connector 300 includes one or more terminal position assurance (TPA) devices 150 coupled to the connector housing 304. The TPA devices 150 are used to ensure that the terminals 306 are properly loaded and retained in the connector housing 304. In the illustrated embodiment, the TPA devices 150 are coupled to the rear 313 of the connector housing 304. The cables 302 extend through the TPA devices 150. Proper installation of the TPA devices 150 provides assurance to the installer that the terminals 306 are properly installed within the connector housing 304.

In an exemplary embodiment, the electrical connector 300 is configured to be mounted to another component, such as a panel. For example, the electrical connector 300 may be received in a panel opening in the panel such that the mating end 310 of the connector housing 304 is located forward of the panel and the cable end 312 of the connector housing 304 is located rearward of the panel. The electrical connector 300 includes mounting tabs 315 and a latch 317 used to secure the electrical connector 300 to the panel. For example, the mounting tabs 315 may engage a rear side of the panel in the latch 317 may be latchably coupled to a front side of the panel. The latch 317 is deflectable to allow removal of the electrical connector 300 from the panel. Optionally, mounting tabs 315 and latches 317 may be provided at both the top and the bottom of the connector housing 304. Other types of mounting features may be used in alternative embodiments to secure the electrical connector 300 to the panel. For example, fasteners may be used to secure the electrical connector 300 to the panel.

In an exemplary embodiment, the connector housing 304 includes latching features 314 used to secure the electrical connector 300 to the electrical connector 200. For example, the latching features 314 may be latching tabs extending from the sides of the connector housing 304. Each latching tab may include a latching surface. The connector housing 204 includes latches 214 that interface with the latching features 314 to secure the electrical connector 200 to the electrical connector 300. The latches 214 are provided at opposite sides of the connector housing 204. The latches 214 are deflectable latches configured to be released from the latching features 314 to allow removal of the electrical connector 200 from the electrical connector 300.

In an exemplary embodiment, a facial seal 120 is provided at the mating interface 110 between the electrical connectors 200, 300. The facial seal 120 is configured to be sealingly coupled to the front 211 of the connector housing 204 and is configured to be sealingly coupled to the front 311 of the connector housing 304. The facial seal 120 provides a sealed interface between the electrical connectors 200, 300. In an exemplary embodiment, the facial seal 120 extend circumferentially around the perimeter of the connector housing 204 and/or the connector housing 304. The facial seal 120 may be compressed between the connector housings 204, 304 when the electrical connectors 200, 300 are mated. The facial seal 120 may be a sealing gasket. In various embodiments, the facial seal 120 is manufactured from a rubber material. In various embodiments, the cables 202 and/or the cables 302 may be sealed within the connector housings 204, 304, respectively. For example, cable seals (not shown) may be provided between the cables 202 and the connector housing 204 and/or between the cables 302 and the connector housing 304.

In the illustrated embodiment, the electrical connectors are twelve position electrical connectors 200, 300. The terminals and cables are arranged in a 4×3 matrix (4 columns×3 rows). However, greater or fewer rows and columns of terminals and cables may be used in alternative embodiments, such as in a 3×3 matrix (3 columns×3 rows), in a 2×3 matrix (2 columns×3 rows), in a 4×1 matrix (4 columns×1 rows), in a 3×1 matrix (3 columns×1 rows), in a 2×1 matrix (2 columns×1 rows), and the like. Other types of electrical connectors having a different number of terminal positions may be provided in other embodiments.

FIG. 3 is an exploded view of the electrical connector system 100 in accordance with an exemplary embodiment. The electrical connector system 100 includes the first and second electrical connectors 200, 300 and a facial seal 120 between the first and second electrical connectors 200, 300. FIG. 3 shows subsets of the terminals 206 poised for loading into the connector housing 204 and one of the TPA devices 140 poised for loading into the connector housing 204. FIG. 3 shows subsets of the terminals 306 poised for loading into the connector housing 304 and one of the TPA devices 150 poised for loading into the connector housing 304.

The connector housing 204 includes a base 220 and a plurality of terminal cavities 230 extending through the base 220. The terminal cavities 230 receive corresponding terminals 206. In an exemplary embodiment, the base 220 extends between a top 222 and a bottom 224 of the connector housing 204. The base 220 extends between a first side 226 and a second side 228 of the connector housing 204. The base 220 may be generally rectangular shaped. However, the base 220 may have other shapes in alternative embodiments.

In an exemplary embodiment, the connector housing 204 includes terminal tubes 232 extending forward from the base 220 to the front 211 of the connector housing 204 and cable tubes 234 extending rearward from the base 220 to the rear 213 of the connector housing 204. The terminal cavities 230 are open through the terminal tubes 232 and the cable tubes 234. The terminals 206 are received in the corresponding terminal tubes 232. The cables 202 are received in the corresponding cable tubes 234. Optionally, the terminals 206 may extend into the cable tubes 234 to connect with the cables 202. In various embodiments, the base 220 may be approximately centered between the front 211 and the rear 213. For example, the terminal tubes 232 may have lengths approximately equal to the cable tubes 234. However, in alternative embodiments, the base 220 may be closer to the front 211 or closer to the rear 213. In the illustrated embodiment, the terminal tubes 232 and the cable tubes 234 are generally cylindrical. However, the terminal tubes 232 and/or the cable tubes 234 may have other shapes in alternative embodiments.

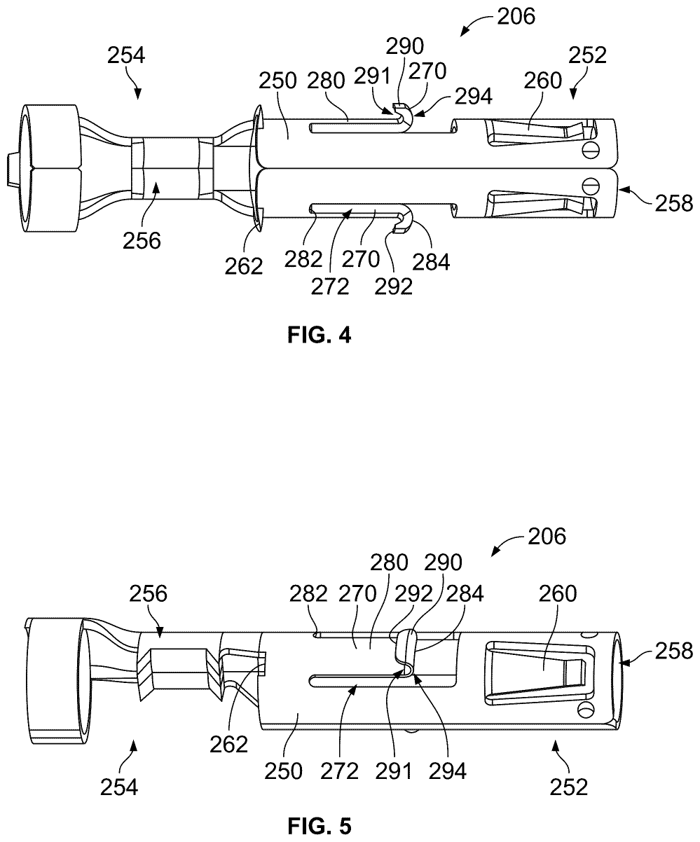

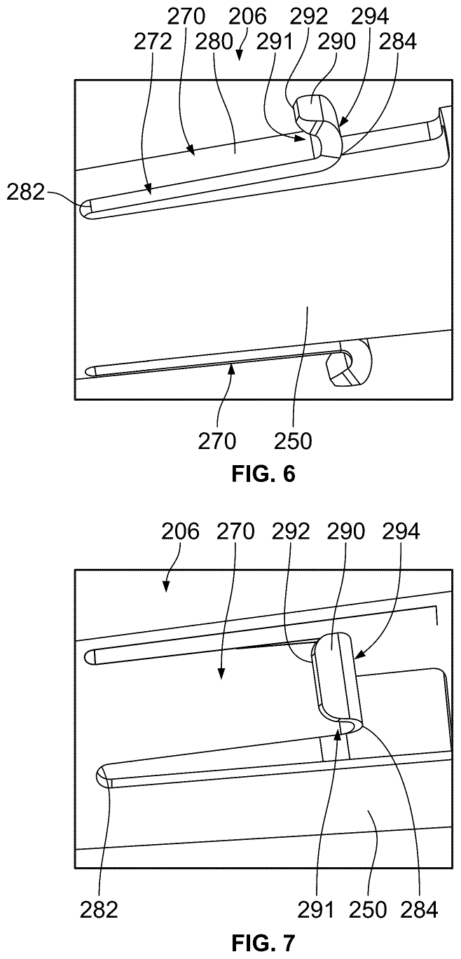

With additional reference to FIGS. 4 and 5, which are front perspective views of an exemplary embodiment of the terminal 206, and FIGS. 6 and 7, which are enlarged views of a portion of the terminal 206, each terminal 206 includes a main body 250 extending between a mating end 252 and a terminating end 254. The main body 250 may be cylindrical, such as being tube shaped. The terminating end 254 is configured to be terminated to the cable 202. In an exemplary embodiment, the terminal 206 includes a crimp barrel 256 at the terminating end 254 configured to be crimped to the end of the cable 202. In an exemplary embodiment, the terminal 206 includes a socket 258 at the mating end 252. The socket 258 is configured to receive a pin of the terminal 306 (FIG. 3). In an exemplary embodiment, the terminal 206 is stamped and formed. For example, the terminal 206 may be stamped from a metal sheet and formed into a tubular shape defining the socket 258 at the mating end 252.

In an exemplary embodiment, the terminal 206 includes mating beams 260 proximate to the front of the main body 250. Each mating beam 260 is stamped from the main body 250 and formed to have a curved mating interface proximate to the distal end thereof. The mating beam 260 is bent inward to extend into the socket 258 to interface with the terminal 306. The mating beam 260 is deflectable and configured to be deflected outward when interfacing with the terminal 306. Such deflection creates an internal spring force that biases the mating beam 260 inward toward the terminal 306 to maintain mechanical and electrical connection with the terminal 306.

In an exemplary embodiment, the terminal 206 includes a locating tab 262 at the rear of the main body 250. The locating tab 262 may extend radially outward from the main body 250. In an exemplary embodiment, the locating tab 262 is formed integral with the main body 250, such as being stamped and formed with the main body 250. The locating tab 262 is used to locate the terminal 206 in the connector housing 204, such as to axially position the terminal 206 in the terminal cavity 230. The locating tab 262 may be a stop tab used to stop forward movement or loading of the terminal 206 in the terminal cavity 230 when the locating tab 262 bottoms out against a stop surface in the terminal cavity 230. Optionally, multiple locating tabs 262 may be provided circumferentially around the terminal 206.

In an exemplary embodiment, the terminal 206 includes locking lances 270 extending from the main body 250. The locking lances 270 are used to secure the terminal 206 in the connector housing 204. For example, the locking lance 270 is configured to engage a portion of the base 220, such as a retention shoulder (not shown) of the base 220, to prevent axial movement of the terminal 206 in the terminal cavity 230. In an exemplary embodiment, the locking lances 270 are formed integral with the main body 250. For example, the locking lances 270 are stamped and formed from the main body 250. In the illustrated embodiment, two locking lances 270 are provided and positioned on opposite side of the terminal 206. The locking lances 270 may be used to coaxially position the terminal 206 in the corresponding terminal cavity 230, such as to radially center the terminal 206 in the terminal cavity 230. For example, the locking lances 270 may be flexible and configured to be spring biased against the connector housing 204 to center the terminal 206 in the terminal cavity 230. The locking lances 270 may be located at other positions in alternative embodiments. For example, three locking lances 270 may be provided at 1200 offsets to triangulate coaxial positioning in the terminal cavity 230.

Each locking lance 270 includes a lance arm 280 and a retention finger 290 extending from the lance arm 280 to a retention edge 292. In an exemplary embodiment, the lance arm 280 extends in the axial direction of the terminal 206. For example, the lance arm 280 may extend forwardly. The lance arm 280 may extend in the direction of the mating end of the terminal 206. The retention finger 290 extends transversely relative to the lance arm 280. For example, the retention finger 290 may extend transversely to the axis of the terminal 206 In an exemplary embodiment, the retention finger 290 protrudes generally outwardly and rearwardly. For example, the retention finger 290 is bent or folded to extend generally in the opposite direction from the lance arm 280. The retention finger 290 extends generally toward the terminating end rather than the mating end. The retention finger 290 forms a retention pocket 291 between the retention finger 290 and the lance arm 280. The retention finger 290 is configured to engage the connector housing 204 to hold the terminal 206 in the terminal cavity 230. For example, the retention edge 292 and/or the interior surface of the retention finger 290 is configured to engage a retention shoulder in the terminal cavity 230 to retain the terminal 206 in the corresponding terminal cavity 230. In an exemplary embodiment, the retention shoulder is configured to be received inside the retention pocket 291. The inside surface of the retention finger 290 may be angled similar to the shape of the retention shoulder to interact and form a locking interface. For example, the retention shoulder may provide a radial outwards force to increase terminal retention force when trying to pull axially to extract the terminal 206. The lance arm 280 extends forwardly from a fixed end 282 to a free end 284. For example, the free end 284 is located forward of the fixed end 282. For example, the free end 284 is located closer to the terminating end 254 at the rear of the main body 250 and the free end 284 is located closer to the mating end 252 at the front of the main body 250. The retention finger 290 extends rearwardly from the free end 284.

In an exemplary embodiment, the lance arm 280 is separated from the main body 250 by slots 272 along either side of the lance arm 280. The slots 272 may be formed by a stamping process to form the locking lance 270 from the main body 250. The slots 272 extend to the fixed end 282. The lance arm 280 is deflectable within the slots 272. In an exemplary embodiment, the lance arm 280 may be bent slightly outward relative to the main body 250, such as to interface with the connector housing 204 when the terminal 206 is plugged into the terminal cavity 230.

In an exemplary embodiment, the locking lance 270 is hook shaped. For example, the retention finger 290 is folded over on the lance arm 280. In an exemplary embodiment, the retention finger 290 is formed by folding or rolling or bending the retention finger 290 outward from the distal end or free end 284 of the lance arm 280. The retention finger 290 is bent to extend rearwardly from the free end 284 at the front of the locking lance 270. The retention finger 290 includes a folded or rolled portion 294 at the transition from the lance arm 280. The retention edge 292 is located rearward of the rolled portion 294. In an exemplary embodiment, the retention finger 290 extends from the lance arm 280 at an angle of between 90° and 180°.

With reference back to FIG. 3, the connector housing 304 includes a base 320 and a plurality of terminal cavities 330 extending through the base 320. The terminal cavities 330 receive corresponding terminals 306. In an exemplary embodiment, the base 320 extends between a top 322 and a bottom 324 of the connector housing 304. The base 320 extends between a first side 326 and a second side 328 of the connector housing 304. The base 320 may be generally rectangular shaped. However, the base 320 may have other shapes in alternative embodiments.

In an exemplary embodiment, the connector housing 304 includes a shroud 340 forming a receptacle 342 that receives the mating end 210 of the connector housing 204. The shroud 340 extends forward from the base 320. The shroud 340 is located at the mating end 310 of the connector housing 304. The shroud 340 is defined by walls along the top 322, the bottom 324, the first side 326 and the second side 328.

In an exemplary embodiment, the connector housing 304 includes terminal tubes 332 extending forward from the base 320 to the front 311 of the connector housing 304 and cable tubes 334 extending rearward from the base 320 to the rear 313 of the connector housing 304. The terminal tubes 332 extend into the receptacle 342. For example, the shroud 340 surrounds the terminal tubes 332. The terminal cavities 330 are open through the terminal tubes 332 and the cable tubes 334. The terminals 306 are received in the corresponding terminal tubes 332. The cables 302 are received in the corresponding cable tubes 334. Optionally, the terminals 306 may extend into the cable tubes 334 to connect with the cables 302. In the illustrated embodiment, the terminal tubes 332 and the cable tubes 334 are generally cylindrical. However, the terminal tubes 332 and/or the cable tubes 334 may have other shapes in alternative embodiments.

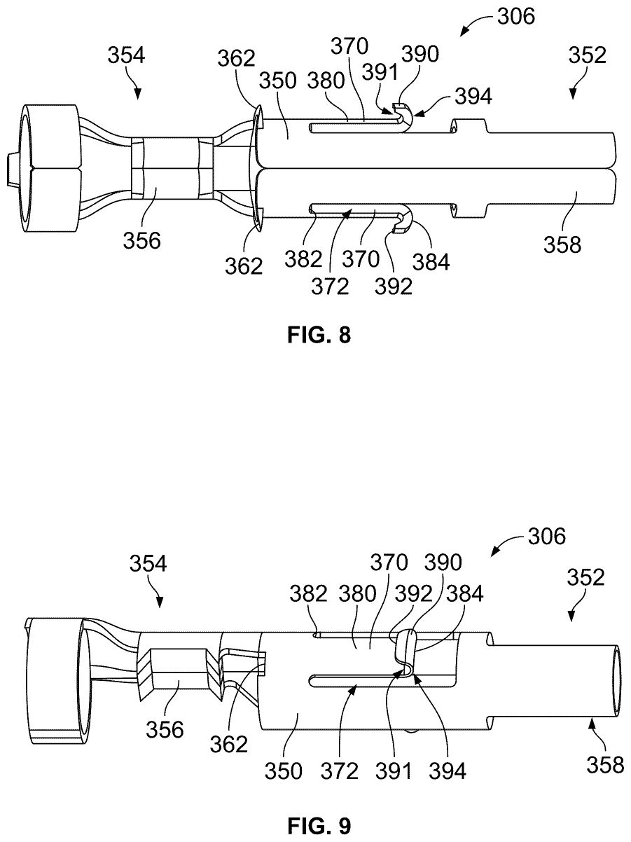

With additional reference to FIGS. 8 and 9, which are front perspective view of an exemplary embodiment of the terminal 306, each terminal 306 includes a main body 350 extending between a mating end 352 and a terminating end 354. The terminating end 354 is configured to be terminated to the cable 302. In an exemplary embodiment, the terminal 306 includes a crimp barrel 356 at the terminating end 354 configured to be crimped to the end of the cable 302.

In an exemplary embodiment, the terminal 306 includes a pin 358 at the mating end 352. The pin 358 is configured to be received in the socket 258 of the terminal 206 (FIG. 4). In an exemplary embodiment, the terminal 306 is stamped and formed. For example, the terminal 306 may be stamped from a metal sheet and formed into a tubular shape with a tapered nose defining the pin 358 at the mating end 352.

In an exemplary embodiment, the terminal 306 includes a locating tab 362 at the rear of the main body 350. The locating tab 362 may extend radially outward from the main body 350. In an exemplary embodiment, the locating tab 362 is formed integral with the main body 350, such as being stamped and formed with the main body 350. The locating tab 362 is used to locate the terminal 306 in the connector housing 304, such as to axially position the terminal 306 in the terminal cavity 330. The locating tab 362 may be a stop tab used to stop forward movement or loading of the terminal 306 in the terminal cavity 330 when the locating tab 362 bottoms out against a stop surface in the terminal cavity 330. Optionally, multiple locating tabs 362 may be provided circumferentially around the terminal 306.

In an exemplary embodiment, the terminal 306 includes locking lances 370. The locking lances 370 are used to secure the terminal 306 in the connector housing 304. The locking lances 370 may be similar to the locking lances 270 (FIGS. 4 and 5). The locking lances 370 are configured to engage a portion of the base 320, such as a retention shoulder (not shown) of the base 320, to prevent axial movement of the terminal 306 in the terminal cavity 330. In an exemplary embodiment, the locking lances 370 are formed integral with the main body 350. For example, the locking lances 370 are stamped and formed from the main body 350.

Each locking lance 370 includes a lance arm 380 and a retention finger 390 extending from the lance arm 380 to a retention edge 392. In an exemplary embodiment, the lance arm 380 extends in the axial direction of the terminal 306. For example, the lance arm 380 may extend forwardly. The lance arm 380 may extend in the direction of the mating end of the terminal 306. The retention finger 390 extends transversely relative to the lance arm 380. For example, the retention finger 390 may extend transversely to the axis of the terminal 306 In an exemplary embodiment, the retention finger 390 protrudes generally outwardly and rearwardly. For example, the retention finger 390 is bent or folded to extend generally in the opposite direction from the lance arm 380. The retention finger 390 extends generally toward the terminating end rather than the mating end. The retention finger 390 forms a retention pocket 391 between the retention finger 390 and the lance arm 380. The retention finger 390 is configured to engage the connector housing 304 to hold the terminal 306 in the terminal cavity 330. For example, the retention edge 392 and/or the interior surface of the retention finger 390 is configured to engage a retention shoulder in the terminal cavity 330 to retain the terminal 306 in the corresponding terminal cavity 330. In an exemplary embodiment, the retention shoulder is configured to be received inside the retention pocket 391. The inside surface of the retention finger 390 may be angled similar to the shape of the retention shoulder to interact and form a locking interface. For example, the retention shoulder may provide a radial outwards force to increase terminal retention force when trying to pull axially to extract the terminal 306. The lance arm 380 extends forwardly from a fixed end 382 to a free end 384. For example, the free end 384 is located forward of the fixed end 382. For example, the free end 384 is located closer to the terminating end 354 at the rear of the main body 350 and the free end 384 is located closer to the mating end 352 at the front of the main body 350. The retention finger 390 extends rearwardly from the free end 384. The lance arm 380 is deflectable about the fixed end 384 within the slots 372.

In an exemplary embodiment, the locking lance 370 is hook shaped. For example, the retention finger 390 is folded over on the lance arm 380 to face in generally the opposite direction from the lance arm 380. In an exemplary embodiment, the retention finger 390 is formed by folding or rolling or bending the retention finger 390 outward from the distal end or free end 384 of the lance arm 380. The retention finger 390 is bent to extend rearwardly from the free end 384 at the front of the locking lance 370. The retention finger 390 includes a folded or rolled portion 394 at the transition from the lance arm 380. The retention edge 392 is located rearward of the rolled portion 394. In an exemplary embodiment, the retention finger 390 extends from the lance arm 380 at an angle of between 90° and 180°.

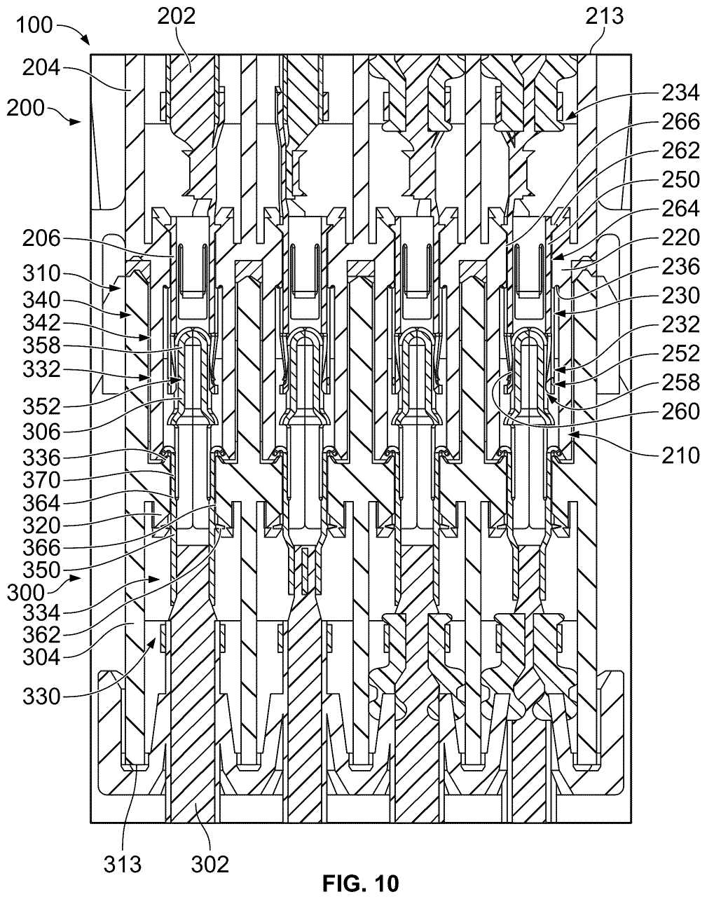

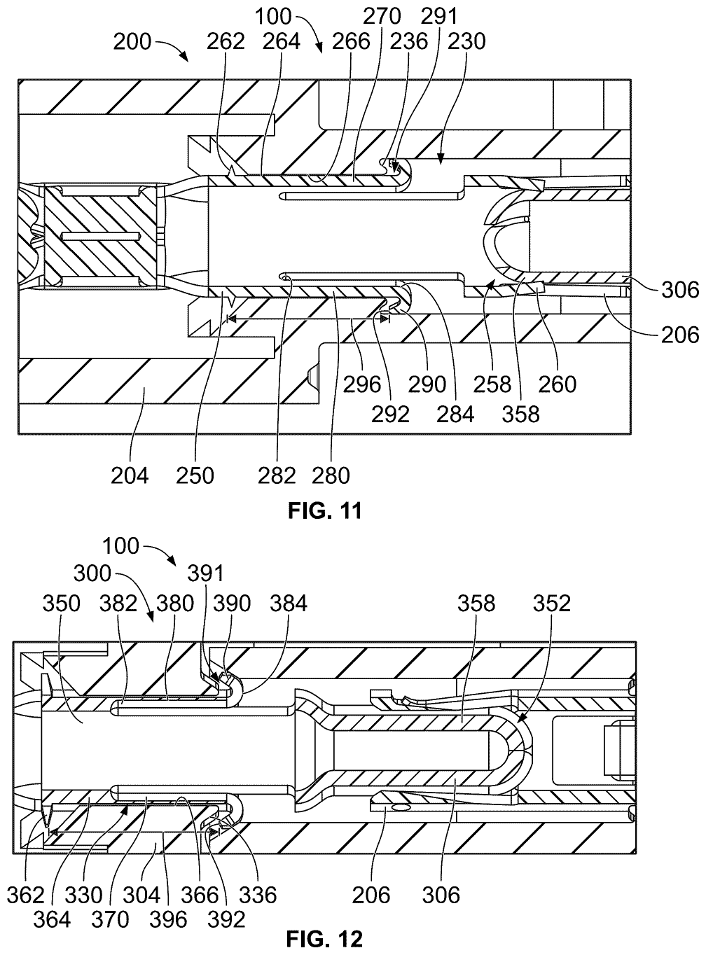

FIG. 10 is a sectional view of the electrical connector system 100 showing the first electrical connector 200 and the second electrical connector 300 mated together. FIG. 11 is an enlarged view of a portion of the electrical connector system 100 showing one of the terminals 206 positioned in the connector housing 204. FIG. 12 is an enlarged view of a portion of the electrical connector system 100 showing one of the terminals 306 positioned in the connector housing 304.

Each locking lance 270 includes the lance arm 280 extending generally forwardly and the retention finger 290 extending generally rearwardly from the lance arm 280 to the retention edge 292. The lance arm 280 extends forwardly in the axial direction of the terminal 206 from a fixed end 282 to a free end 284. In an exemplary embodiment, the locking lance 270 is hook shaped. For example, the retention finger 290 is folded over on the lance arm 280. The retention finger 290 extends transversely, such as obliquely (for example, obtusely), relative to the lance arm 280. The retention finger 290 is bent to extend rearwardly from the free end 284 to the retention edge 292. The retention edge 292 is configured to engage the connector housing 204 to hold the terminal 206 in the terminal cavity 230.

In an exemplary embodiment, the base 220 of the connector housing 204 includes a retention shoulder 236 (FIG. 11) within the terminal cavity 230. The retention shoulder 236 is forward facing (for example, faces the electrical connector 300). The retention shoulder 236 may be angled, such as being a ramped surface, that is angled rearwardly. The shape/angle of the retention shoulder 236 may be complimentary to the shape/angle of the retention finger 290. The locking lance 270 is configured to engage the retention shoulder 236 to retain the terminal 206 in the terminal cavity 230. For example, after the locking lance 270 is loaded into the terminal cavity 230 beyond the retention shoulder 236, the locking lance 270 springs outward to engage the retention shoulder 236 and prevent pullout of the terminal 206 from the terminal cavity 230. In an exemplary embodiment, the retention shoulder 236 is configured to be received inside the retention pocket 291. The inside surface of the retention finger 290 may be angled similar to the shape of the retention shoulder 236 to interact and form a locking interface. For example, the retention shoulder 236 may provide a radial outwards force to increase terminal retention force when trying to pull axially to extract the terminal 206.

Each locking lance 370 includes the lance arm 380 extending generally forwardly and the retention finger 390 extending generally rearwardly from the lance arm 380 to the retention edge 392. The lance arm 380 extends forwardly in the axial direction of the terminal 306 from a fixed end 382 to a free end 384. In an exemplary embodiment, the locking lance 370 is hook shaped. For example, the retention finger 390 is folded over on the lance arm 380. The retention finger 390 extends transversely, such as obliquely (for example, obtusely), relative to the lance arm 380. The retention finger 390 is bent to extend rearwardly from the free end 384 to the retention edge 392. The retention edge 392 is configured to engage the connector housing 304 to hold the terminal 306 in the terminal cavity 330.

In an exemplary embodiment, the base 320 of the connector housing 304 includes a retention shoulder 336 (FIG. 12) within the terminal cavity 330. The retention shoulder 336 is forward facing (for example, faces the electrical connector 200). The retention shoulder 336 may be angled, such as being a ramped surface, that is angled rearwardly. The shape/angle of the retention shoulder 336 may be complimentary to the shape/angle of the retention finger 390. The locking lance 370 is configured to engage the retention shoulder 336 to retain the terminal 306 in the terminal cavity 330. For example, after the locking lance 370 is loaded into the terminal cavity 330 beyond the retention shoulder 336, the locking lance 370 springs outward to engage the retention shoulder 336 and prevent pullout of the terminal 306 from the terminal cavity 330. In an exemplary embodiment, the retention shoulder 336 is configured to be received inside the retention pocket 391. The inside surface of the retention finger 390 may be angled similar to the shape of the retention shoulder 336 to interact and form a locking interface. For example, the retention shoulder 336 may provide a radial outwards force to increase terminal retention force when trying to pull axially to extract the terminal 306.

During assembly, the terminals 206 and cables 202 are loaded into the connector housing 204, such as through the rear 213. The terminals 206 and cables 202 are loaded into the terminal cavities 230 through the cable tubes 234. The terminals 206 pass through the base 220 into the terminal tubes 232. The sockets 258 at the mating ends 252 of the terminals 206 are positioned in the terminal tubes 232 for mating with the terminals 306. When the terminals 206 are fully inserted into the connector housing 204, the locking lances 270 flex outward to engage the connector housing 204 to hold the terminals 206 in the connector housing 204. For example, the lance arms 280 may spring outward to position the retention fingers 290 of the locking lances 270 in the terminal cavity 230 to interface with the retention shoulder of the base 220. The locking lances 270 prevent rearward pullout of the terminals 206 from the connector housing 204. In an exemplary embodiment, the locating tabs 262 are used to position the terminals 206 in the terminal cavities 230. For example, the locating tabs 262 engage a stop shoulder of the connector housing 204 to axially position the terminals 206 in the connector housing 204.

In an exemplary embodiment, the retention edge 292 is located a distance 296 from the locating tabs 262. The distance may be a predetermined distance for the particular connector housing 204 to axially locate the terminal 206 in the terminal cavity 230. For example, the distance 296 may be a controlled distance between the retention shoulder (engaged by the retention edge 292) and the stop shoulder (engaged by the locating tabs 262) to axially position the terminal 206 in the terminal cavity 230. The main body 250 is cylindrical or tubular between the retention edge 292 and the locating tabs 262. The portion of the main body 250 between the retention edge 292 and the locating tabs 262 is a locating portion 264 of the main body 250. The locating portion 264 is used to coaxially position the terminal 206 in the terminal cavity 230. For example, the locating portion 264 is may be axially aligned with the central axis of the terminal cavity 230. In an exemplary embodiment, the lance arms 280 of the locking lances 270 are located along the locating portion 264. For example, the lance arms 280 extend along the space between the locating tabs 262 and the retention edge 292. The lance arms 280 may center the terminal 206 in the terminal cavity 230. For example, the base 220 may include a locating tube 266 extending at least a length of the corresponding terminal cavity 230. The locating portion 264 is received in the locating tube 266 to axially position the terminal 206 in the terminal cavity 230. The lance arms 280 are located along the locating portion 264 and are received in the locating tube 266 to center the terminal 206 in the locating tube 266. In an exemplary embodiment, both the locating tube 266 and the locating portion 264 are cylindrical. The lance arms 280 are flexed outward against the locating tube 266 to radially position the terminal 206 in locating tube 266.

During assembly, the terminals 306 and cables 302 are loaded into the connector housing 304, such as through the rear 313. The terminals 306 and cables 302 are loaded into the terminal cavities 330 through the cable tubes 334. The terminals 306 pass through the base 320 into the terminal tubes 332. The pins 358 at the mating ends 352 of the terminals 306 are positioned in the terminal tubes 332 for mating with the sockets 258 of the terminals 206. When the terminals 306 are fully inserted into the connector housing 304, the locking lances 370 flex outward to engage the connector housing 304 to hold the terminals 306 in the connector housing 304. For example, the lance arms 380 may spring outward to position the retention fingers 390 of the locking lances 370 in the terminal cavity 330 to interface with the retention shoulder of the base 320. The locking lances 370 prevent rearward pullout of the terminals 306 from the connector housing 304. In an exemplary embodiment, the locating tabs 362 are used to position the terminals 306 in the terminal cavities 330. For example, the locating tabs 362 engage a stop shoulder of the connector housing 304 to axially position the terminals 306 in the connector housing 304.

In an exemplary embodiment, the retention edge 392 is located a distance 396 from the locating tabs 362. The distance may be a predetermined distance for the particular connector housing 304 to axially locate the terminal 306 in the terminal cavity 330. For example, the distance 396 may be a controlled distance between the retention shoulder (engaged by the retention edge 392) and the stop shoulder (engaged by the locating tabs 362) to axially position the terminal 306 in the terminal cavity 330. The main body 350 is cylindrical or tubular between the retention edge 392 and the locating tabs 362. The portion of the main body 350 between the retention edge 392 and the locating tabs 362 is a locating portion 364 of the main body 350. The locating portion 364 is used to coaxially position the terminal 306 in the terminal cavity 330. For example, the locating portion 364 is may be axially aligned with the central axis of the terminal cavity 330. In an exemplary embodiment, the lance arms 380 of the locking lances 370 are located along the locating portion 364. For example, the lance arms 380 extend along the space between the locating tabs 362 and the retention edge 392. The lance arms 380 may center the terminal 306 in the terminal cavity 330. For example, the base 320 may include a locating tube 366 extending at least a length of the corresponding terminal cavity 330. The locating portion 364 is received in the locating tube 366 to axially position the terminal 306 in the terminal cavity 330. The lance arms 380 are located along the locating portion 364 and are received in the locating tube 366 to center the terminal 306 in the locating tube 366. In an exemplary embodiment, both the locating tube 366 and the locating portion 364 are cylindrical. The lance arms 380 are flexed outward against the locating tube 366 to radially position the terminal 306 in locating tube 366.

During mating, the mating end 210 of the connector housing 204 is plugged into the receptacle 342 at the mating end 310 of the connector housing 304. The shroud 340 surrounds the mating end 210 of the connector housing 204. In an exemplary embodiment, the terminal tubes 232 are loaded into the terminal tubes 332. The terminals 206 are mated to the terminals 306. For example, the pins 358 are loaded into the sockets 258. The mating beams 260 engage the pins 358 of the terminals 306 to electrically engage the terminals 206 to the terminals 306.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
a connector housing including a base and a plurality of terminal cavities extending through the base, the base including a retention shoulder within each terminal cavity; and
terminals received in the corresponding terminal cavities, each terminal including a main body extending between a mating end at a front of the terminal and a terminating end at a rear of the terminal, the mating end configured to be mated to a mating terminal, the terminating end configured to be terminated to a cable, each terminal including a locking lance extending from the main body, the locking lance including a lance arm extending in the axial direction of the terminal and a retention finger extending transversely from the lance arm to a retention edge, the retention edge engaging the corresponding retention shoulder to retain the terminal in the corresponding terminal cavity.

2. The electrical connector of claim 1, wherein the locking lance is hook shaped with the lance arm extending generally forwardly and the retention finger extending generally rearwardly.

3. The electrical connector of claim 1, wherein the retention finger protrudes outward from a distal end of the lance arm to form a retention pocket, the retention pocket configured to receive the retention shoulder.

4. The electrical connector of claim 1, wherein the retention finger extends from the lance arm at an angle of between 90° and 180°.

5. The electrical connector of claim 1, wherein the lance arm is separated from the main body by slots, the lance arm being deflectable within the slots.

6. The electrical connector of claim 1, wherein the lance arm extends between a fixed end and a free end, the fixed end located rearward of the free end, the fixed end being fixed to the main body, the retention finger extending from the free end.

7. The electrical connector of claim 6, wherein the fixed end is located closer to the terminating end and the free end is located closer to the mating end.

8. The electrical connector of claim 1, wherein the main body includes locating tabs at a rear of the main body, the retention edge located a distance from the locating tabs, the lance arm located in the space between the locating tabs and the retention edge.

9. The electrical connector of claim 1, wherein the base includes a locating tube extending at least a length of the corresponding terminal cavity, the main body of the terminal having a locating portion received in the locating tube to axially position the terminal in the terminal cavity, the locking arm located along the locating portion and received in the locating tube.

10. The electrical connector of claim 9, wherein the locating tube is cylindrical, the locating portion of the main body being cylindrical.

11. The electrical connector of claim 9, wherein the lance arm is flexed outward against the locating tube to radially position the terminal in locating tube.

12. The electrical connector of claim 1, wherein the locking lance is a first locking lance, the terminal including a second locking lance opposite the first locking lance, the first and second locking lances being flexed outward to engage the base and coaxially center the terminal in the terminal cavity between the locking lances.

13. The electrical connector of claim 1, wherein the locking lance engages the retention shoulder to prevent axial movement of the terminal in the terminal cavity.

14. An electrical connector comprising:
a connector housing including a base and a plurality of terminal cavities extending through the base, the base including a retention shoulder within each terminal cavity; and
terminals received in the corresponding terminal cavities, each terminal including a main body extending between a mating end at a front of the terminal and a terminating end at a rear of the terminal, the mating end configured to be mated to a mating terminal, the terminating end configured to be terminated to a cable, each terminal including a locking lance extending from the main body, the locking lance including a lance arm extending between a fixed end and a free end, the fixed end located rearward of the free end, the locking lance including a retention finger extending from the free end engaging the corresponding retention shoulder to retain the terminal in the corresponding terminal cavity.

15. The electrical connector of claim 14, wherein the locking lance is hook shaped forming a retention pocket between the lance arm and the retention finger, the retention pocket configured to receive the retention shoulder.

16. The electrical connector of claim 14, wherein the fixed end is located closer to the terminating end and the free end is located closer to the mating end.

17. The electrical connector of claim 14, wherein the base includes a locating tube extending at least a length of the corresponding terminal cavity, the main body of the terminal having a locating portion received in the locating tube to axially position the terminal in the terminal cavity, the locking arm located along the locating portion and received in the locating tube

18. An electrical connector comprising:
a connector housing including a base and a plurality of terminal cavities extending through the base, the base extending between a front and a rear, the base including a locating tube extending at least a length of each terminal cavity, the base including a retention shoulder within each terminal cavity forward of the locating tube; and
terminals received in the corresponding terminal cavities, each terminal including a main body extending between a mating end at a front of the terminal and a terminating end at a rear of the terminal, the mating end configured to be mated to a mating terminal, the terminating end configured to be terminated to a cable, the main body having a locating portion received in the locating tube to coaxially position the terminal in the terminal cavity, each terminal including a locking lance extending from the main body, the locking lance including a lance arm extending forwardly generally in the axial direction of the terminal, the lance arm located along the locating portion and received in the locating tube, the locking lance including a retention finger protruding outwardly and transversely to the lance arm and extending generally rearwardly from the lance arm to a retention edge, the retention edge engaging the corresponding retention shoulder to retain the terminal in the corresponding terminal cavity.

19. The electrical connector of claim 18, wherein the locating tube is cylindrical, the locating portion of the main body being cylindrical.

20. The electrical connector of claim 18, wherein the lance arm is flexed outward against the locating tube to radially position the terminal in locating tube.
